(19) United States
(12) Patent Application Publication
(10) Pub. No.: US 2007/0116405 A1
(43) Pub. Date: May 24, 2007

(54) Optical-radiation projection

(76) Inventors: David M. Kane, Rowley, MA (US); Jeff T. Daiker, Tucson, AZ (US)

Correspondence Address: PETER I. LIPPMAN, 17900 MOCKINGBIRD LANE, RENO, NV, 89506, US

(21) Appl. No.: 11/431,209

(22) Filed: May 10, 2006

Related U.S. Application Data
(60) Provisional application No. 60/680,119, filed on May 11, 2005.

(51) Int. Cl. G02B 6/26; G02B 6/42

(52) U.S. Cl. 385/18

(57) ABSTRACT

This projection method and apparatus use laser illumination, beam steering with a microelectromechanical-system (“MEMS”) mirror or array, and an afocal lens to magnify the MEMS deflections. In some preferred forms of the invention a beam splitter—preferably of polarization type—cooperates with a quarter-wave plate to transmit the radiation beam in one pass through the splitter and reflect the beam in another pass, thus cleanly separating the source subassembly from the processing and output subassemblies.

### RELATION BACK

This document is based upon and claims priority of our U.S. Provisional Patent Application 60/680,119, filed May 11, 2005.

Other related documents include patent applications Ser. Nos. 11/151,594, and 11/015,285, of David Kane.

### FIELD OF THE INVENTION

This invention relates generally to projector systems and methods, and more specifically to such technology that uses laser illumination, beam steering with a microelectromechanical-system (“MEMS”) mirror or array, and an afocal lens to magnify the MEMS deflections.

### BACKGROUND

Many kinds of image projection are known. One approach shown by Troyer in U.S. Pat. No. 6,183,092 uses laser sources, liquid-crystal light valves for optical-phase modulation of the beams by a video-based image, and an afocal lens for exploiting the spatial modulation within a diverging beam to obtain extreme image sharpness at very great projection distances.

Troyer also requires an oscillating mirror to successively paint shallow slices of the image into the projection space. Due to these several subsystems, the Troyer technology may be relatively expensive, or particularly oversensitive to operational details. Additionally of interest are several patents cited in the Troyer prosecution, particularly including Minich and Knize.

Original uses of the Texas Instruments MEMS technology were for projection; however, they did not employ laser radiation or an afocal lens. Neither Troyer nor the TI teachings appear to suggest such any combination.

### CONCLUSION

From the foregoing it can be seen that prior art fails to provide economical, simple practical projection methods or systems using laser imaging with an afocal lens. Thus important aspects of the technology used in the field of the invention remain amenable to useful refinement.

### BRIEF SUMMARY OF THE INVENTION

The present invention introduces just such refinement. In preferred embodiments the invention has several independent aspects or facets, which are advantageously used in conjunction together, although they are capable of practice independently.

In preferred embodiments of its first major independent facet or aspect, the invention is image projecting apparatus that includes at least one radiation source forming a radiation beam. It also includes a MEMS mirror, or mirror array, deflecting the beam.

The apparatus further includes an afocal optic magnifying the beam deflection. The optic may be a mirror but is preferably a lens.

In addition the apparatus includes a beam splitter. It directs the beam along:
a first path from the at least one source to the mirror or array, and
a second path from the mirror or array to the optic.

Further included are some means for introducing at least one constant phase delay, substantially uniform across the splitter, between the first and second paths. For purposes of breadth and generality in discussing the invention, these means may be called simply the “introducing means”.

The foregoing may represent a description or definition of the first aspect or facet of the invention in its broadest or most general form. Even as couched in these broad terms, however, it can be seen that this facet of the invention importantly advances the art.

In particular, the beam splitter enables easy access to the MEMS apparatus, by cleanly separated optical source and projection beams in a very compact configuration—arising from internal sweep by the fine MEMS devices. At the same time, in the projection space the system enjoys high magnification of the small MEMS deflections as a result of the afocal optic. As will be seen, actual enjoyment of these advantages is facilitated by certain preferences described below.

Although the first major aspect of the invention thus significantly advances the art, nevertheless to optimize enjoyment of its benefits preferably the invention is practiced in conjunction with certain additional features or characteristics. In particular, preferably the beam splitter is a polarization beam splitter. Due to the splitter, both the first and second paths are (or are enabled to be) roughly normal to the mirror or array. The introducing means include a fixed retarder through which both the first and second paths pass.

If this basic preference is observed, then further preferably the retarder is or includes a quarter-wave plate; and the beam is polarized. I this case the two passes through the plate, in the two paths, reverse the interaction of the beam with the splitter, with respect to transmission and reflection.

If the quarter-wave plate and polarized-beam preference is also observed, then—still further preferably—in one pass the polarizer transmits the beam, and in the other pass the splitter reflects the beam. More specifically in the first pass the polarizer may transmit the beam, and in the second pass, due to the reversal, the splitter may reflect the beam.

We prefer, however, that in the first pass the polarizer reflect the beam. In this case, in the second pass—due to the reversal—the splitter transmit the beam.

A further preference is that the source include at least three light sources at different wavelengths, and that the apparatus further include:
some means for combining radiation from the three sources to form a single beam for deflection by the mirror or array (these combining means may, merely by way of example, include spectral-bandpass filters), and
some means for generating, receiving or storing data defining an image, and
some means for applying image data from the generating-receiving-or-storing means to control (by generally conventional raster- or vector-sweep techniques) the deflection by the mirror or array.
   Other preferences will become clear in the discussions that follow.

In preferred embodiments of a second major independent facet or aspect, the invention is in essence all of the elements and preferences introduced above. This second facet of the invention is particularly advanced beyond the prior art by virtue of combining together all of those elements and preferences.

In preferred embodiments of its third major independent facet or aspect, the invention is a method for imaging a scene. For purposes of this facet of the invention, the term “scene” is to be understood as encompassing a diagrammatic display, or a map, or graph, or any other assemblage of visual elements that can be human perceived or machine sensed.

The method includes the step of projecting a radiation beam from at least one radiation source to a MEMS mirror, or mirror array. It also includes the step of operating the mirror or array to deflect the beam.

Another step is transmitting the deflected beam through an afocal optic to magnify the beam deflection. Still another is passing the beam through a beam splitter to direct the beam along:
a first path from the at least one source to the mirror or array, and
a second path from the mirror or array to the optic.
   A further step is introducing at least one constant phase delay, substantially uniform across the splitter, between the first and second paths.

The foregoing may represent a description or definition of the third aspect or facet of the invention in its broadest or most general form. Even as couched in these broad terms, however, it can be seen that this facet of the invention importantly advances the art. In particular, the advantages of this method substantially parallel those of the first apparatus aspect of the invention discussed above.

Although the third major aspect of the invention thus significantly advances the art, nevertheless to optimize enjoyment of its benefits preferably the invention is practiced in conjunction with certain additional features or characteristics. In particular, preferably the passing step includes passing the beam twice through a polarization beam splitter. Due to the splitter, the first and second paths are roughly normal to the mirror or array; and the introducing step includes passing the beam twice through a quarter-wave plate.

Also preferably, in one pass the polarizer transmits the beam and in the other pass the splitter reflects the beam. Thus one preference is that in the first pass the polarizer reflect the beam; and in the second pass, due to the reversal, the splitter transmit the beam.

The foregoing features and benefits of the invention will be more fully appreciated from the following detailed description of preferred embodiments—with reference to the appended drawings, of which:

### BRIEF DESCRIPTION OF THE DRAWINGS

FIG. 1 is a block diagram, highly schematic, of a projection system according to preferred embodiments of the invention, particularly using an optical path in which a polarized beam-splitter first reflects and then transmits the beam—first to and then from the MEMS mirror or mirrors; and

FIG. 2 is a like diagram according to other preferred embodiments in which the sequence is opposite—i. e., the splitter first transmits and then later reflects.

### DETAILED DESCRIPTION OF PREFERRED EMBODIMENTS

Preferred embodiments of the invention have an afocal optic—i. e. a mirror or preferably a lens assembly that does not focus the output beam—and a MEMS mirror, or MEMS-mirror array, to deflect the output beam. The deflection is controlled in a sweep arrangement to form either raster or vector images.

One central feature is a beam splitter, preferably a polarization type of splitter, through which the output beam passes once en route from the source or sources to the mirror or array, and then again en route from the mirror or array to the afocal optic and the projection space. By passing the beam through the splitter twice, once in transmission and once in reflection, the system achieves nominally normal reflection at the mirror or array, and this condition in turn simplifies and optimizes the system.

According to preferred embodiments of the present invention, such double passage through the splitter is enabled by insertion of a single fixed retarder—in common—in both paths, i. e. to and from the mirror or array. The amount of phase retardation in each pass is doubled, after two passes, so that alignment between the radiation polarization plane and the splitter interface plane is “P” or “parallel” in one of the two encounters, and “S” or “perpendicular” in the other.

With parallel alignment the output beam can pass through the splitter—whether before or after the mirror or array—and with perpendicular alignment the beam is constrained to reflect from the splitter. Advantageously, these two conditions facilitate very clean separation of the source beams from the output beam, with a large angle (generally ninety degrees) between them.

This geometry is achieved, in the present invention, with no need for a liquid-crystal light valve such as used in Troyer. Also unlike her apparatus, here the phase retardation—between the two passes through the splitter—is uniform across the splitter aperture. Troyer teaches retardation that is highly varying both spatially (the light valves in effect “write” the instantaneous image in phase retardation) and temporally.

The present invention achieves temporally varying images by, instead, a simpler raster or vector scanning arrangement. If modulated intensity or brightness is desired, that can be provided by modulating the laser intensity during scanning.

Troyer too has a scanning stage, with intensity modulation, but it is part of a preliminary video module that drives the light valves. Hence the intervening liquid-crystal light valve, in each color-primary channel, may be seen as an additional intermediate module—better eliminated as by the present invention. If preferred a 50/50 beam splitter can be substituted for the polarized splitter.

The afocal optic enables the swept output beam to cover a much larger field of view than would be possible otherwise, in a compact configuration. Details of the system follow.

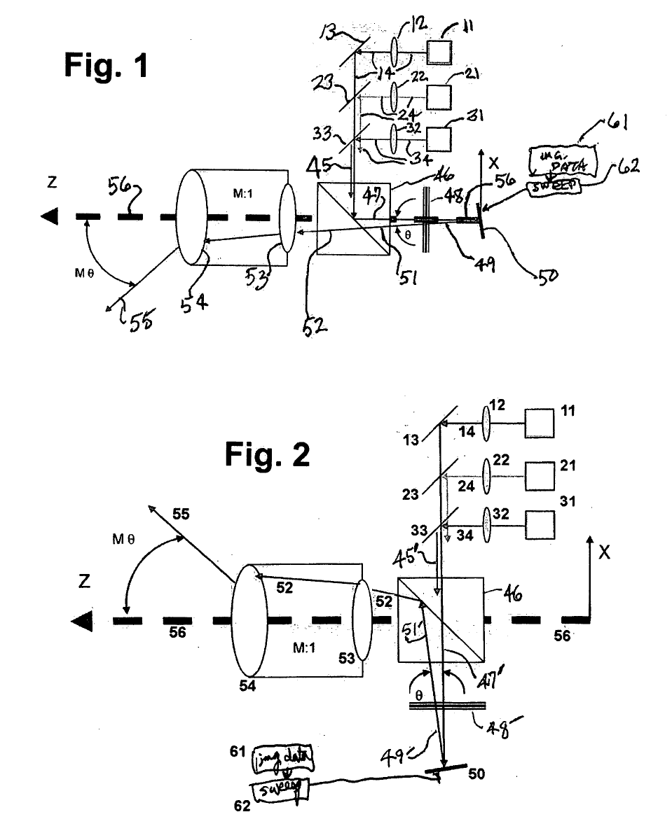

One or more laser sources 11, 21, 31 (FIG. 1) generate collimated beams 14, 24, 34 that pass through lenses 12, 22, 32. For ordinary imaging in the visible, we prefer that the three laser sources emit red, green and blue light. The invention, however, is by no means limited to three color channels or to visible wavebands, but to the contrary is entirely amenable to addition or substitution of other laser sources. Hence the three channels discussed here are merely exemplary.

The beams are reflected 13, 23, 33 for injection into the afocal MEMS beam-steering (“AMBS”) projector along an axis 14, 24, 34, 45 that is nominally normal to the projection optical axis Z, 56-56. These sources of different wavelengths can be transmitted along the same optical axis through the use of spectral-bandpass beam splitters 13, 23, 33 that transmit in one or more wavebands and reflect at other wavelengths. All wavelengths of radiation, in the beam 45 first approaching the polarized splitter 46, are “S”-polarized and therefore first reflect from the splitter 46 at a ninety-degree angle—to travel 47 through a quarter-wave plate 48 and toward the MEMS mirror or array 50.

The mirror or array 50 is angled, under electronic control, to rotate and thereby deflect the beam about the X and Y axes as required to project the beam to a desired location in object space—e. g. for vector- or raster-construction of an image to be viewed or machine-sensed. In this example the array or mirror 50 is rotated by an angle θ/2, with a resulting angle θ relative to the Z-axis.

In other words the beam is deflected by an angle θ inside the optical system. After this combined reflection and deflection, the beam next passes a second time through the quarter-wave plate 48 and back toward the splitter 46.

In each pass through the quarter-wave plate 48 the polarization angle is rotated about the optical axis Z, 56-56 by (preferably) forty-five degrees. Therefore when the beam reaches the interface plane of the splitter 46 for the second time the polarization plane has been rotated by a total of ninety degrees.

Accordingly, upon return, the beam is no longer “S”-polarized relative to the interface plane. Rather it is then “P”-polarized, and therefore transmitted by the splitter.

The polarized splitter 46 is a preferred embodiment because approximately 95% of the radiation energy from the laser sources 11, 21, 31 can be transmitted through the system. As will be clear to people skilled in this field, other polarization approaches can be substituted to obtain a like effect. Alternative embodiments using a 50/50 beam splitter would work; however, only 25% or less of the energy would be transmitted.

After its second passage through the polarized beam splitter 49 and quarter-wave plate 48, the radiation 42 reaches an afocal lens (or other optical) assembly 53, 54 with angular magnification M. Here the projection angle out of the system is magnified, becoming Mθ.

Operation of the mirror or mirror array 50 is under very generally conventional electronic sweep control 62, as prescribed by image data 61. The latter may be generated by the apparatus—or associated apparatus—in real time.

Alternatively, image data may be only received by the apparatus from local or remote image-generating means such as a computer, graphics work station, or information-gathering apparatus that creates a projection image from the gathered information—e. g. technical sensor outputs. Still another option is that image data may be simply stored for use, having been received or assembled previously. In any event image data from the generating, receiving and/or storing subsystems are applied to control the deflection θ by the mirror or array, and thereby the resulting deflection Mθ in the external projection space. If gray-scale (rather than only black-and-white “bitmap”) and/or variable-chroma imaging is desired, then imaging information should also be applied (not shown) to modulate the laser intensities.

Uses of this apparatus include, but are not limited to, heads-up displays for automobiles and for other vehicles of all types. The embodiment described is operable for radiation ranging from 250 through 12,000 nm. Within this range, in the visible portion of the spectrum, images are suited for direct human viewing. If instead projected in ultraviolet radiation, they remain useful for machine sensing and interpretation, or for conversion as by a fluorescent or phosphorescent medium to an image that is directly human viewable. Analogously if projected in the infrared they can be seen with night-vision eyeware even though not visible to the public, or to passengers or operators lacking such equipment.

In an alternative configuration, the beam 45′ (FIG. 2) is first transmitted through the beam splitter 46 and reflected in its second approach 51′. This change, from the configuration first described, can be effectuated by e. g. a relative rotation of the entire input assembly 11-14, 21-24, 31-34, about the beam axis 45, with respect to the entire optical-processor assembly 46-54.

The foregoing disclosure is not to be understood as limiting or exhaustive. Rather, it is only exemplary of the invention, whose scope is to be determined from the appended claims.

Image projecting apparatus comprising:
at least one radiation source forming a radiation beam;
a MEMS mirror, or mirror array, deflecting the beam;
an afocal optic magnifying the beam deflection;
a beam splitter for directing the beam along:
   a first path from the at least one source to the mirror or array, and
   a second path from the mirror or array to the optic; and
means for introducing at least one constant phase delay, substantially uniform across the splitter, between the first and second paths.

The apparatus of claim 1, wherein:
the beam splitter is a polarization beam splitter;
due to the splitter, both the first and second paths are roughly normal to the mirror or array; and
the introducing means comprise a fixed retarder through which both the first and second paths pass.

The apparatus of claim 2, wherein:
the retarder comprises a quarter-wave plate; and
the beam is polarized;
wherein the two passes through the plate, in the two paths, reverse the interaction of the beam with the splitter, with respect to transmission and reflection.

The apparatus of claim 3, wherein:
in one pass the polarizer transmits the beam; and
in the other pass the splitter reflects the beam.

The apparatus of claim 3, wherein:
in the first pass the polarizer transmits the beam; and
in the second pass, due to said reversal, the splitter reflects the beam.

The apparatus of claim 3, wherein:
in the first pass the polarizer reflects the beam; and
in the second pass, due to said reversal, the splitter transmits the beam.

The apparatus of claim 6:
wherein the source comprises at least three light sources at different wavelengths; and
further comprising:
   means for combining radiation from the three sources to form a single beam for deflection by the mirror or array,
   means for generating, receiving or storing data defining an image,
   means for applying image data from the generating-receiving-or-storing means to control the deflection by the mirror or array.

The apparatus of claim 7, wherein:
the applying means comprise means for controlling the deflection to sweep the beam in a raster or vector pattern to form a projected image.

The apparatus of claim 7, wherein:
the sources comprise a source of visible radiation.

The apparatus of claim 7, wherein:
the sources comprise a source of ultraviolet radiation.

The apparatus of claim 7, wherein:
the sources comprise a source of infrared radiation.

Image projecting apparatus comprising:
means for generating, receiving or storing data defining an image;
at least three radiation sources at different wavelengths, with radiation beams combining to form a polarized radiation beam;
a MEMS mirror, or mirror array, deflecting the beam;
an afocal optic magnifying the beam deflection;
a polarization beam splitter for directing the combined beam on a first path from the sources roughly normal to the mirror or array, and on a second path roughly normal from the mirror or array to the optic;
a quarter-wave plate for introducing a total phase delay of substantially one-half wave between the first and second paths;
wherein the splitter reflects the beam in one of the two paths and transmits the beam in the other of the two paths; and
means for applying image data from the generating-receiving-or-storing means to control the deflection by the mirror or array in a raster or vector pattern to form a projected image.

The apparatus of claim 12, wherein:
the sources comprise a source of visible radiation.

The apparatus of claim 12, wherein:
the sources comprise a source of ultraviolet radiation.

The apparatus of claim 12, wherein:
the sources comprise a source of infrared radiation.

A method for imaging a scene; said method comprising the steps of:
projecting a radiation beam from at least one radiation source to a MEMS mirror, or mirror array;
operating the mirror or array to deflect the beam;
transmitting the deflected beam through an afocal optic to magnify the beam deflection;
passing the beam through a beam splitter to direct the beam along:
   a first path from the at least one source to the mirror or array, and
   a second path from the mirror or array to the optic; and
introducing at least one constant phase delay, substantially uniform across the splitter, between the first and second paths.

The method of claim 16, wherein:
the passing step comprises passing the beam twice through a polarization beam splitter;
due to the splitter, the first and second paths are roughly normal to the mirror or array; and
the introducing step comprise passing the beam twice through a quarter-wave plate.

The apparatus of claim 17, wherein:
in one pass the polarizer transmits the beam; and
in the other pass the splitter reflects the beam.

The apparatus of claim 18, wherein:
in the first pass the polarizer reflects the beam; and
in the second pass, due to said reversal, the splitter transmits the beam.

I claim:

1. Image projecting apparatus comprising:
at least one radiation source forming a radiation beam;
a MEMS mirror, or mirror array, deflecting the beam;
an afocal optic magnifying the beam deflection;
a beam splitter for directing the beam along:
a first path from the at least one source to the mirror or array, and
a second path from the mirror or array to the optic; and
means for introducing at least one constant phase delay, substantially uniform across the splitter, between the first and second paths.

2. The apparatus of claim 1, wherein:
the beam splitter is a polarization beam splitter;
due to the splitter, both the first and second paths are roughly normal to the mirror or array; and
the introducing means comprise a fixed retarder through which both the first and second paths pass.

3. The apparatus of claim 2, wherein:
the retarder comprises a quarter-wave plate; and
the beam is polarized;
wherein the two passes through the plate, in the two paths, reverse the interaction of the beam with the splitter, with respect to transmission and reflection.

4. The apparatus of claim 3, wherein:
in one pass the polarizer transmits the beam; and
in the other pass the splitter reflects the beam.

5. The apparatus of claim 3, wherein:
in the first pass the polarizer transmits the beam; and
in the second pass, due to said reversal, the splitter reflects the beam.

6. The apparatus of claim 3, wherein:
in the first pass the polarizer reflects the beam; and
in the second pass, due to said reversal, the splitter transmits the beam.

7. The apparatus of claim 6:
wherein the source comprises at least three light sources at different wavelengths; and
further comprising:
means for combining radiation from the three sources to form a single beam for deflection by the mirror or array,
means for generating, receiving or storing data defining an image,
means for applying image data from the generating-receiving-or-storing means to control the deflection by the mirror or array.

8. The apparatus of claim 7, wherein:
the applying means comprise means for controlling the deflection to sweep the beam in a raster or vector pattern to form a projected image.

9. The apparatus of claim 7, wherein:
the sources comprise a source of visible radiation.

10. The apparatus of claim 7, wherein:
the sources comprise a source of ultraviolet radiation.

11. The apparatus of claim 7, wherein:
the sources comprise a source of infrared radiation.

12. Image projecting apparatus comprising:
means for generating, receiving or storing data defining an image;
at least three radiation sources at different wavelengths, with radiation beams combining to form a polarized radiation beam;
a MEMS mirror, or mirror array, deflecting the beam;
an afocal optic magnifying the beam deflection;
a polarization beam splitter for directing the combined beam on a first path from the sources roughly normal to the mirror or array, and on a second path roughly normal from the mirror or array to the optic;
a quarter-wave plate for introducing a total phase delay of substantially one-half wave between the first and second paths;
wherein the splitter reflects the beam in one of the two paths and transmits the beam in the other of the two paths; and
means for applying image data from the generating-receiving-or-storing means to control the deflection by the mirror or array in a raster or vector pattern to form a projected image.

13. The apparatus of claim 12, wherein:
the sources comprise a source of visible radiation.

14. The apparatus of claim 12, wherein:
the sources comprise a source of ultraviolet radiation.

15. The apparatus of claim 12, wherein:
the sources comprise a source of infrared radiation.

16. A method for imaging a scene; said method comprising the steps of:
projecting a radiation beam from at least one radiation source to a MEMS mirror, or mirror array;
operating the mirror or array to deflect the beam;
transmitting the deflected beam through an afocal optic to magnify the beam deflection;
passing the beam through a beam splitter to direct the beam along:
a first path from the at least one source to the mirror or array, and
a second path from the mirror or array to the optic; and
introducing at least one constant phase delay, substantially uniform across the splitter, between the first and second paths.

17. The method of claim 16, wherein:
the passing step comprises passing the beam twice through a polarization beam splitter;
due to the splitter, the first and second paths are roughly normal to the mirror or array; and
the introducing step comprises passing the beam twice through a quarter-wave plate.

18. The apparatus of claim 17, wherein:
in one pass the polarizer transmits the beam; and
in the other pass the splitter reflects the beam.

19. The apparatus of claim 18, wherein:
in the first pass the polarizer reflects the beam; and
in the second pass, due to said reversal, the splitter transmits the beam.
